(19) United States
(12) Patent Application Publication
(10) Pub. No.: US 2010/0263854 A1
(43) Pub. Date: Oct. 21, 2010

(54) HEAT EXCHANGER FOR A COOLING SYSTEM OF A COMBUSTION ENGINE

(75) Inventors: Mario Eckmann, Verden/Aller (DE); Martin Rosenbecker, Schwuelper (DE); Bernd Seiler, Hannover (DE)

Correspondence Address: LOWE, HAUPTMAN, HAM & BERNER, LLP (ITW), 1700 DIAGONAL ROAD, SUITE 300, ALEXANDRIA, VA, 22314, US

(73) Assignee: ITW AUTOMOTIVE PRODUCTS GMBH & CO. KG, Iserlohn (DE)

(21) Appl. No.: 12/301,779

(22) PCT Filed: Aug. 3, 2007
(86) PCT No.: PCT/IB2007/002245

§ 371 Date: Nov. 21, 2008

(30) Foreign Application Priority Data
Aug. 9, 2006 (DE) 10 2006 037 212.3

(51) Int. Cl. G05D 23/01

(52) U.S. Cl. 165/287

(57) ABSTRACT

A heat exchanger for an internal combustion engine's cooling system, said heat exchanger comprising a main and an auxiliary circuit and comprising two separated regions, one large region communicating by means of a first radiator tank with the main cooling circuit and the other, small region communicating by means of a second radiator tank with the auxiliary cooling circuit, characterized in that the radiator tanks may communicate with each other through a connection aperture receiving a controlled closing element and in that a drive acting on said closing element is used to selectively open or close the said connection aperture.

The present invention relates to a heat exchanger for an internal combustion engine (ICE) cooling system defined in the preamble of claim 1.

It is state of the art to use such internal combustion engine heat exchangers to cool a liquid coolant, in particular water. Cooling extends not only to the engine, namely the engine block, but for instance also to the transmission oil and the recirculated exhaust gas. Accordingly it is known to divide a conventional heat exchanger—or radiator—into two separate portions, namely a large and a small portion. The small portion is connected to a low caloric cooling circuit and the large one to a high caloric cooling circuit.

The objective of the present invention is to create an internal combustion engine heat exchanger allowing boosting cooling as required.

This problem is solved by the features of claim 1.

In the heat exchanger of the present invention, portions of radiator tanks may be connected to each other through a connecting aperture fitted with a controlled locking element. Using an appropriate locking element drive, said element is selectively moved into the open or closed position.

The present invention is based on the insight that (in the state of the art) the low caloric cooling circuit is at least nearly completely closed when the internal combustion engines is running at full load. As a result only part of the entire heat exchanger is available to the high caloric cooling circuit in the conventional design. In the invention on the other hand the full heat exchanger capacity is being used at full load. As a result the total heat exchanger capacity may be designed to meet the need at full load. Accordingly, keeping constant the internal combustion engine heat exchanger's cooling output, the heat exchanger of the present invention may be made smaller than it is in conventional ones

In one embodiment mode of the present invention, the said locking element may be a flap or a slider. Said drive illustratively may be pneumatic or electromechanical.

In an alternative design of the present invention, said drive may be a thermally expanding element responding to the high caloric cooling circuit temperature. When said temperature reaches the operating temperature, said sealing element may be opened to make available the full heat exchanger capacity.

Illustrative embodiment modes of the present invention are elucidated below in relation to the appended drawings.

FIG. 1 is a section of a heat exchanger of the invention, the flap being closed,

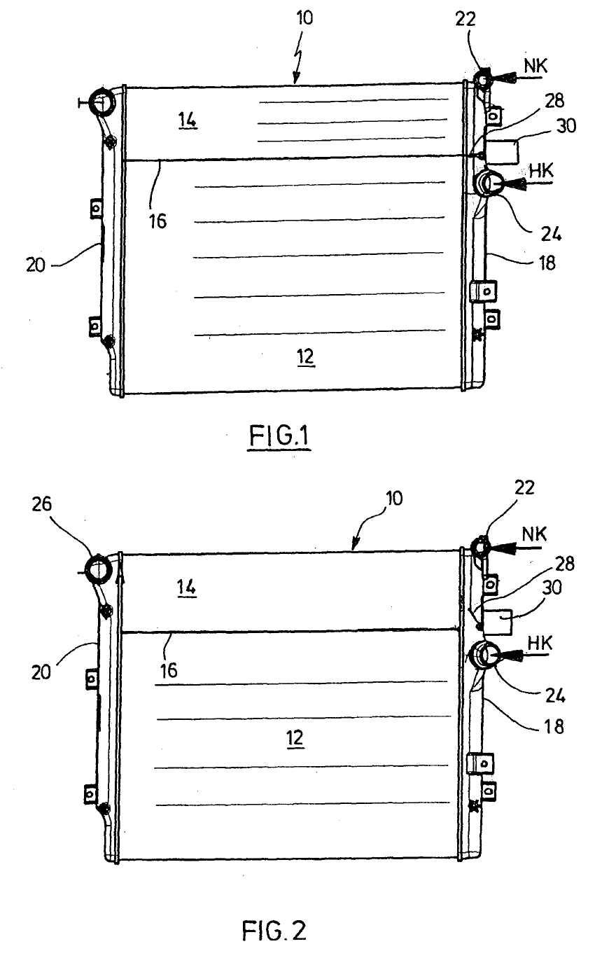

FIG. 2 shows the heat exchanger of FIG. 1 wherein the flap is partly open, and

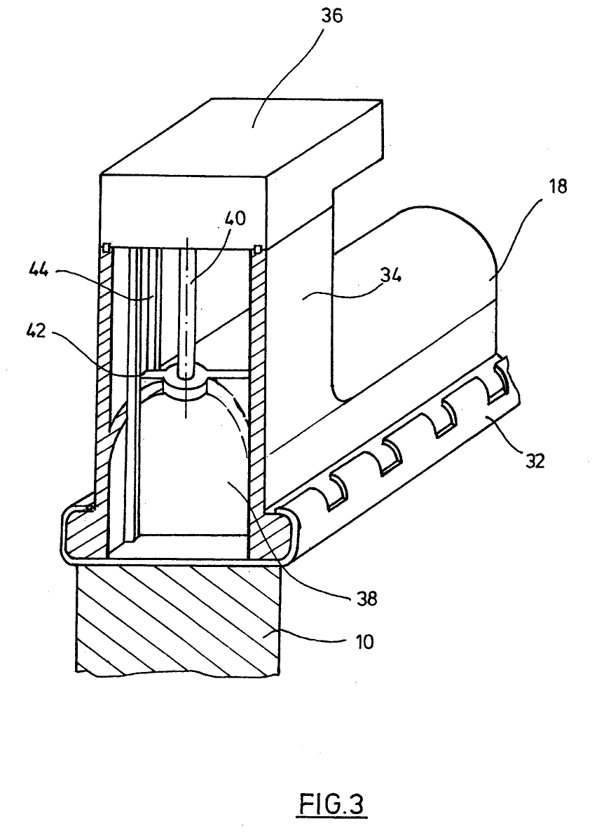

FIG. 3 is a perspective of a radiator tank region of a heat exchanger fitted with a slider and its actuation.

FIGS. 1 and 2 show a heat engine radiator 10. The internal radiator design is omitted. Said design is conventional. The radiator 10 is divided into two portions, namely a large portion 12 and a small portion 14. The radiator portions 12, 14 are separated by a partition 16. A radiator tank 18 respectively 20 is situated on each side of the radiator 10. In its upper region the radiator tank 18 is fitted with a port 22 communicating with an auxiliary circuit (AC). No details are shown for the internal combustion engine using the radiator 10. Such a cooling system is conventional. It includes an auxiliary cooling circuit and a main cooling circuit. The main cooling circuit foremost cools the engine and the auxiliary circuit illustratively cools the recirculated exhaust gases. The portion of the radiator tank 18 allotted to the large radiator region 12 communicates with a port 24 communicating with the main cooling circuit (MC). A port 26 at the left radiator tank 20 drains the cooled coolant such as water from both radiator portions 12, 14.

A flap 28 is configured in the radiator tank 18 and is driven by a flap drive 30. Said flap is closed in FIG. 1 and partly open in FIG. 2. When the flap 28 is closed both the main and the auxiliary cooling circuits are separately cooled by the cooling zones 12, 14. On the other hand, if the flap 28 is open, the coolant flows from the main cooling circuit into the zone 14. The auxiliary cooling circuit not being needed when for instance the internal combustion engine is operating at full load, the cooling zone 14 is not needed to cool the coolant in the auxiliary circuit and as a result the cooling capacity, which had been previously limited to the zone 12, now may be enlarged by the cooling zone 14.

FIG. 3 shows part of the radiator tank 18 which is mounted by a tubular base 32 on the radiator 10. Two mutually spaced apart plates 34 are welded on the radiator tank and support a drive 36 driving a slider 38. The slider 38 is actuated by a rod 40, which in turn is actuated by the drive 36. The slider 38 is fitted with guide elements 42 running inside guide grooves on the inside of the plates 34, one of which is shown at 44. Said drive may be pneumatic or electromechanical, also a thermally expanding element exposed to the temperature in the main cooling circuit (not shown).

1. A heat exchanger for an internal combustion engine's cooling system, said heat exchanger comprising a main and an auxiliary circuit and comprising two separated regions, one large region communicating by means of a first radiator tank with the main cooling circuit and the other, small region communicating by means of a second radiator tank with the auxiliary cooling circuit, characterized in that the radiator tanks may communicate with each other through a connection aperture receiving a controlled closing element and in that a drive acting on said closing element is used to selectively open or close the said connection aperture.

2. Heat exchanger as claimed in claim 1, characterized in that the locking element is a flap or a slider.

3. Heat exchanger as claimed in claim 1, characterized in that its drive is pneumatic or electromechanical.

4. Heat exchanger as claimed in claim 1, characterized in that the drive is thermally expansible and driven by the temperature of the main cooling circuit.

5. Heat exchanger as claimed in claim 1, characterized in that a cooling system control is fitted with a sensor determining when the auxiliary cooling circuit is fully or extensively closed, i.e., whether the internal combustion engine has reached its operating temperature.
